(19) United States
(12) Patent Application Publication
(10) Pub. No.: US 2014/0102378 A1
(43) Pub. Date: Apr. 17, 2014

(54) ROTARY SHEDDING BLADE DRILL ATTACHMENT FOR GROOMING

(71) Applicant: Jason McHan Crippen, Knoxville, TN (US)

(72) Inventor: Jason McHan Crippen, Knoxville, TN (US)

(21) Appl. No.: 13/652,428

(22) Filed: Oct. 15, 2012

(51) Int. Cl. A01K 13/00

(52) U.S. Cl. 119/601; 119/600

(57) ABSTRACT

A rotary shedding blade drill attachment includes a plurality of shedding blades disposed between plates rotatable by a shaft. The rotary shedding blade drill attachment includes a plurality of shedding blades that can turn by mechanical power, such as by a cordless drill. Unlike conventional shedding blades, which includes a single blade, or a single blade in a loop, powered through manual labor, the rotary shedding blade drill attachment includes a plurality of shedding blades whose movement is powered through mechanical assistance, thus saving the user time and labor.

### BACKGROUND OF THE INVENTION

The present invention relates to pet grooming tools and, more particularly, to a rotary shedding blade drill attachment for grooming pets.

Conventional shedding blade have a single blade and is time consuming, labor intensive and inefficient. Conventional shedding blade pet grooming is a manual process, requiring significant time and effort for the groomer performing the task.

As can be seen, there is a need for an improved shedding blade that can reduce time and labor involved in the pet shedding blade grooming process.

### SUMMARY OF THE INVENTION

In one aspect of the present invention, a rotary shedding blade drill attachment comprises a blade cage having an upper plate and a lower plate with a plurality of shedding blades disposed between and interconnecting the upper plate with the lower plate; and a shaft attached to the blade cage, wherein turning the shaft causes the blade cage to rotate.

In another aspect of the present invention, a rotary shedding blade drill attachment comprises a blade cage having a round upper plate and a round lower plate with a plurality of shedding blades disposed about an outer circumference of and interconnecting the upper plate with the lower plate; and a shaft attached to the blade cage, wherein turning the shaft causes the blade cage to rotate, wherein the shaft includes a shoulder and a threaded end; and the blade cage is supported on the shaft between the shoulder and a nut threaded on the threaded end of the shaft.

In a further aspect of the present invention, a method for removing hair from a pet comprises attaching a shaft of a rotary shedding blade drill attachment to a drill; turning a blade cage by turning the shaft with the drill, the blade cage having an upper plate and a lower plate with a plurality of shedding blades disposed between and interconnecting the upper plate with the lower plate; and contacting the blade cage to the pet's hair as the blade cage rotates to remove excess hair.

These and other features, aspects and advantages of the present invention will become better understood with reference to the following drawings, description and claims.

### BRIEF DESCRIPTION OF THE DRAWINGS

FIG. 1 is a perspective view of a rotary shedding blade drill attachment, connected with a cordless drill, according to an exemplary embodiment of the present invention;

FIG. 2 is a perspective view of the rotary shedding blade drill attachment of FIG. 1;

FIG. 3 is a side view of the rotary shedding blade drill attachment of FIG. 1;

FIG. 4 is a side detailed view of one of the shedding blades of the rotary shedding blade drill attachment of FIG. 1; and

FIG. 5 is an exploded perspective view of the rotary shedding blade drill attachment of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a rotary shedding blade drill attachment that includes a plurality of shedding blades disposed between plates rotatable by a shaft. The rotary shedding blade drill attachment includes a plurality of shedding blades that can turn by mechanical power, such as by a cordless drill. Unlike conventional shedding blades, which includes a single blade, or a single blade in a loop, powered through manual labor, the rotary shedding blade drill attachment includes a plurality of shedding blades whose movement is powered through mechanical assistance, thus saving the user time and labor.

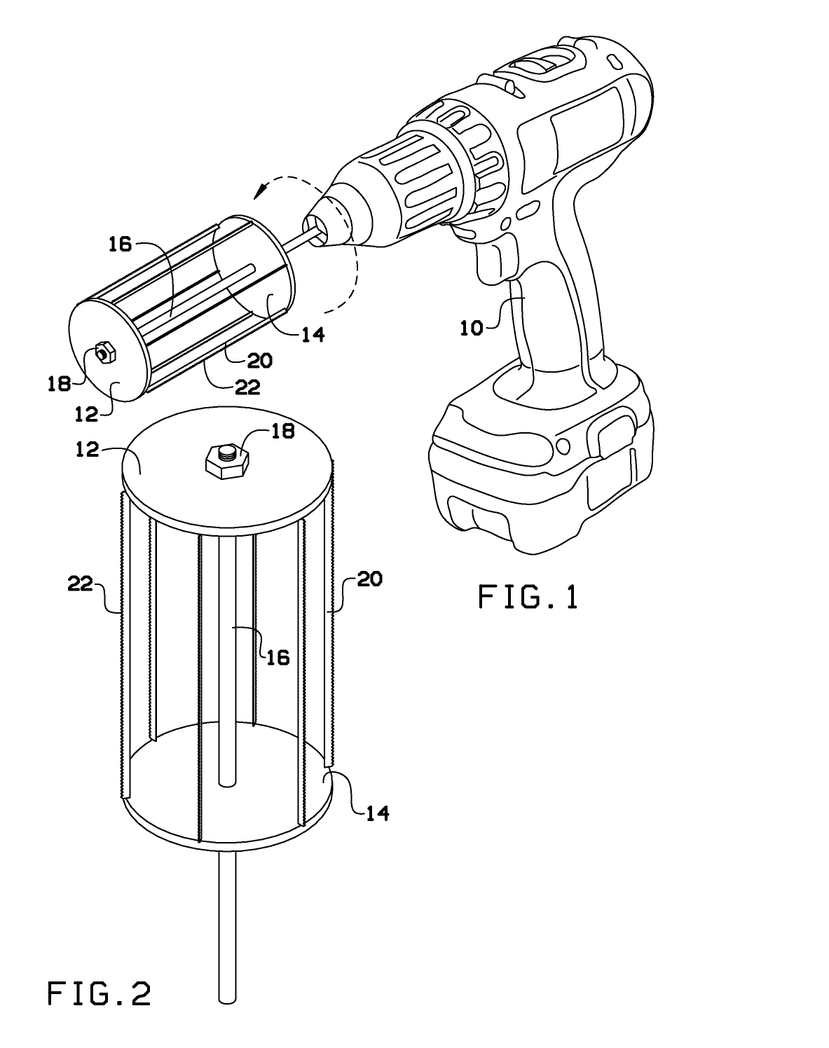

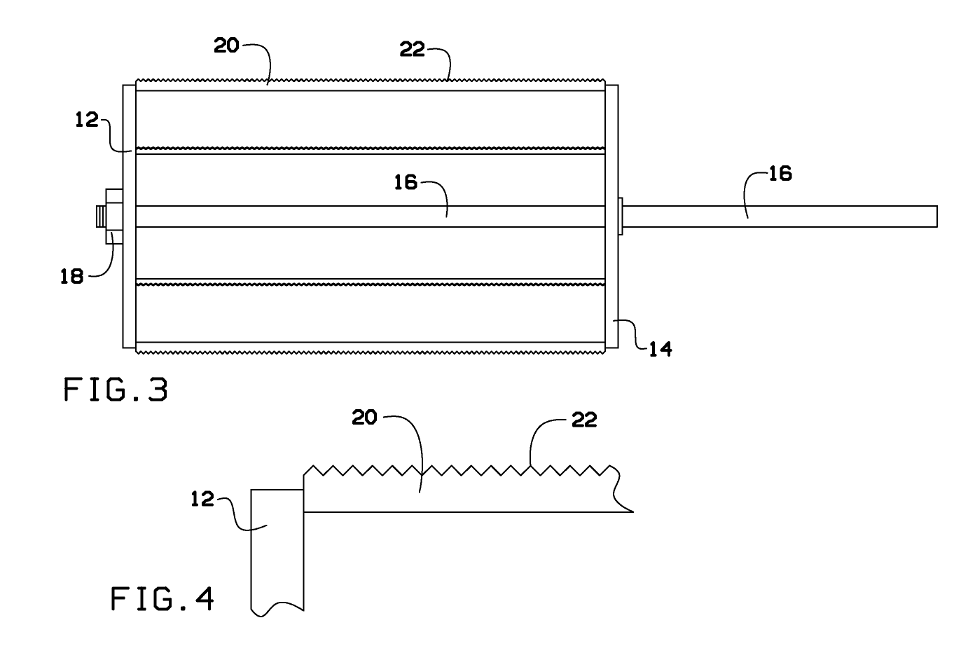

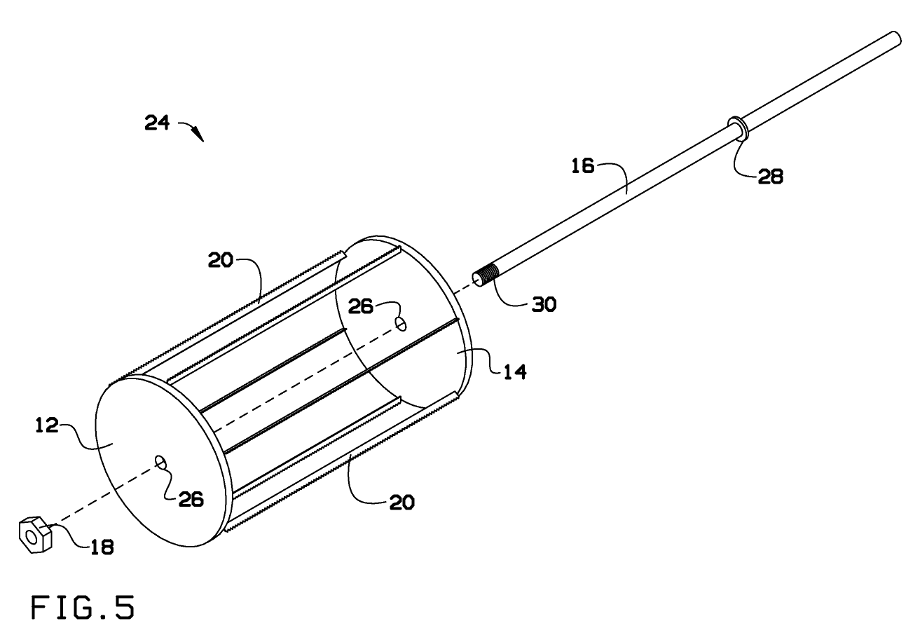

Referring to FIGS. 1 through 5, a rotary shedding blade can include a shaft 16 that can be turned by mechanical assistance, such as by a drill 10. A blade cage 24 can be designed to include an upper plate 12 and a lower plate 14 having a plurality of shedding blades 20 disposed therebetween. Typically, the upper plate 12 and the lower plate 14 can be round plates with the shedding blades 20 connected at and extending outward from an outer circumference of the plates 12, 14. From about 3 to about 10, typically about 6, shedding blades 20 can be disposed between the plates 12, 14. The shedding blades 20 can include a plurality of teeth 22 directed outward from the blade cage 24. The shedding blades 20 are typically spaced evenly apart along the outer circumference of the plates 12, 14 and are typically disposed parallel to the shaft 16. The shedding blades 20 can be formed in various lengths, typically from about 4 to about 8 inches long.

The blade cage 24 can be connected to the shaft 16 by various means. In some embodiments, as shown in the Figures, each of the plates 12, 14 includes a hole 26 disposed in a central region thereof. The shaft 16 can pass through the holes 26 and extend beyond the upper plate 12. A nut 18 may be threaded on threads 30 at the end of the shaft 16. The blade cage 24 can be secured between the nut 18 and a shoulder 28 on the shaft 16. Other connections can be made within the scope of the present invention. For example, the shaft 16 could simply attach to the lower plate 14 with two nuts, one nut and a shoulder or other mechanisms. In some embodiments, the shaft 16 can be welded to the lower plate 14 and/or the upper plate 12. In other embodiments, the shaft 16 can be formed integrally with the lower plate 14 and/or the upper plate 12.

The rotary shedding blade drill attachment can be formed from various materials. Typically, the shaft 16 can be made of a strong material, such as steel, stainless steel, or the like. The blade cage 24 can be formed from various materials, such as steel, stainless steel, plastic, composite, or the like. The shedding blades 20 are typically formed from steel, stainless steel, or the like.

To use the rotary shedding blade drill attachment, the user can simply attach the shaft 16 to the drill 10 and turn the shaft 16 (and thus, the blade cage 24), with the drill 10. As the rotary shedding blade drill attachment turns the user can run the blade cage 24 down the pet's coat, typically in the same direction as the pet's hair growth, removing excess hair from the pet.

It should be understood, of course, that the foregoing relates to exemplary embodiments of the invention and that modifications may be made without departing from the spirit and scope of the invention as set forth in the following claims.

What is claimed is:

1. A rotary shedding blade drill attachment comprising:
a blade cage having an upper plate and a lower plate with a plurality of shedding blades disposed between and interconnecting the upper plate with the lower plate; and
a shaft attached to the blade cage, wherein turning the shaft causes the blade cage to rotate.

2. The rotary shedding blade drill attachment of claim 1, wherein the upper plate and the lower plate are round with the plurality of shedding blades disposed on an outer circumference of the upper plate and the lower plate.

3. The rotary shedding blade drill attachment of claim 1, wherein the plurality of shedding blades includes from about 3 to about 8 shedding blades.

4. The rotary shedding blade drill attachment of claim 1, wherein the plurality of shedding blades includes 6 shedding blades.

5. The rotary shedding blade drill attachment of claim 1, wherein the shaft includes a shoulder and a threaded end.

6. The rotary shedding blade drill attachment of claim 5, wherein the blade cage is supported on the shaft between the shoulder and a nut threaded on the threaded end of the shaft.

7. A rotary shedding blade drill attachment comprising:
a blade cage having a round upper plate and a round lower plate with a plurality of shedding blades disposed about an outer circumference of and interconnecting the upper plate with the lower plate; and
a shaft attached to the blade cage, wherein turning the shaft causes the blade cage to rotate, wherein
the shaft includes a shoulder and a threaded end; and
the blade cage is supported on the shaft between the shoulder and a nut threaded on the threaded end of the shaft.

8. The rotary shedding blade drill attachment of claim 1, wherein the plurality of shedding blades includes 6 shedding blades.

9. A method for removing hair from a pet, comprising:
attaching a shaft of a rotary shedding blade drill attachment to a drill;
turning a blade cage by turning the shaft with the drill, the blade cage having an upper plate and a lower plate with a plurality of shedding blades disposed between and interconnecting the upper plate with the lower plate;
and contacting the blade cage to the pet's hair as the blade cage rotates to remove excess hair.

10. The method of claim 9, wherein the plurality of shedding blades includes about six shedding blades.
